(19) United States
(12) Patent Application Publication
(10) Pub. No.: US 2015/0120313 A1
(43) Pub. Date: Apr. 30, 2015

(54) APPARATUS AND METHOD FOR COLLECTING ADVERSE DRUG EVENT DATA OVER NETWORK

(71) Applicant: ELECTRONICS AND TELECOMMUNICATIONS RESEARCH INSTITUTE, DAEJEON (KR)

(72) Inventors: Hyeon Sung CHO, Daejeon (KR); Rock Won KIM, Daejeon (KR); Yun Kyung PARK, Daejeon (KR); Jong Hyun PARK, Daejeon (KR)

(73) Assignee: ELECTRONICS AND TELECOMMUNICATIONS RESEARCH INSTITUTE, DAEJEON (KR)

(21) Appl. No.: 14/169,643

(22) Filed: Jan. 31, 2014

(30) Foreign Application Priority Data
Oct. 31, 2013 (KR) 10-2013-0131143

(51) Int. Cl. G06F 19/00

(52) U.S. Cl. CPC G06F 19/363
USPC 705/2

(57) ABSTRACT

Provided is a method of collecting an adverse drug event over a network and providing a relevant service. The method includes receiving prescription information and drug-taking comment information from an external device to store the received prescription information and drug-taking comment information in a database (DB), receiving the prescription information to search the DB based on the received prescription information, generating a drug interaction search result through the DB search; and transmitting the generated drug interaction search result to the external device, in which the drug interaction search result includes at least one of information on interaction between a drug of the prescription information and another drug, information on interaction between the drug of the prescription information and a food, information on an adverse drug effect of the drug of the prescription information, and information on components and a manufacturer of the drug of the prescription information.

### CROSS-REFERENCE TO RELATED APPLICATIONS

This application claims priority under 35 U.S.C. §119 to Korean Patent Application No. 10-2013-0131143, filed on Oct. 31, 2013, the disclosure of which is incorporated herein by reference in its entirety.

### TECHNICAL FIELD

The present invention relates to an apparatus and method for collecting adverse drug event data, and more particularly, to an apparatus and method for collecting data on drugs, drug-taking histories, and drug-taking comments from a personal device that is connected to a wired/wireless network.

### BACKGROUND

With recent global aging trends, the frequency and amount of drug-taking are increasing rapidly. The resulting adverse drug events are also increasing rapidly, which may threaten the safety of patients. Accordingly, it is an emerging issue to find and analyze new or serious adverse drug events of commercial drugs in early stages. To this end, it is most important to collect data about drug takers.

In the related art, there is a system for collecting, storing, presenting, and analyzing immunization data, which has a remote station capable of communicating with a vaccine and disease database over a network (Korean Patent Application No. 2004-7016262).

FIG. 1 shows an immunization data system according to the related art. As shown in FIG. 1, an immunization mobile station (IMS; 80) is configured to collect patient information such as biographical data, previous vaccination data, medical history, medication in use, occupation, administration of recent vaccination, disease symptom and the like. The IMS 80 includes tablet PC 81 and digital camera 85. The IMS 80 synchronizes the patient information with information stored in a database 116 maintained at the data center 82 that is accessible to different groups of personnel based on different privileges at the data center and other security measures.

Patients can access electronic patient records generated by the IMS 80, and stored at the IMS and/or a local server and eventually at the data center 82, via telephone or computer (e.g., via web browser). The IMS 80 can capture and store images of vaccination and disease symptom sites on patients. The database 116 allows for vaccination and disease tracking and disease control.

The IMS 80 can be provided with electronic patient consent forms, and are programmable to track adverse events and generate follow-up reports after a vaccine is administered.

However, the related art has limitations in that it is convenient for drug takers to enter and use drug data or drug-taking comment data, it is not easy to search for and analyze adverse drug event information and additional drug effectiveness information, it is difficult for a user to perceive that the adverse drug event may be caused, and the drugs are limited to vaccines and used only in hospitals.

### SUMMARY

Accordingly, the present invention provides an apparatus and method for easily receiving and efficiently collecting and searching for drug data and drug-taking comment data from a personal device connected to a network.

The present invention also provides an apparatus and method for searching for and analyzing additional information about adverse drug events and drug effectiveness.

The present invention also provides core information for an adverse drug event mining system for finding a new adverse drug event case using a set of adverse drug event data collected from persons.

Examples of the personal devices connected to a network include a smartphone, a mobile terminal, a computer connected to the wired Internet, and all other devices capable of connecting to the network.

The present invention also provides an apparatus and method for allowing a user to more easily perceive that the adverse drug event may be caused and for allowing a user to take a prompt action when the adverse drug event is expected to be caused.

In one general aspect, an adverse drug event data system over a network includes: a DB unit configured to include a drug information DB for storing drug information, a drug-taking history DB for storing a drug-taking history, and a drug-taking comment DB for storing a drug-taking comment; a search unit configured to search the DB unit based on prescription information and then generate a drug interaction search result; and a communication unit configured to receive the prescription information and the drug-taking history from an external device and transmit the drug interaction search result to the external device, in which the drug interaction search result includes at least one of information on interaction between a drug of the prescription information and another drug, information on interaction between the drug of the prescription information and a food, information on an adverse drug effect of the drug of the prescription information, and information on components and a manufacturer of the drug of the prescription information.

In another general aspect, a method of searching for adverse drug event data over a network includes: receiving prescription information and drug-taking comment information from an external device to store the received prescription information and drug-taking comment information in a database (DB); receiving the prescription information to search the DB based on the received prescription information; generating a drug interaction search result through the DB search; and transmitting the generated drug interaction search result to the external device, in which the drug interaction search result includes at least one of information on interaction between a drug of the prescription information and another drug, information on interaction between the drug of the prescription information and a food, information on an adverse drug effect of the drug of the prescription information, and information on components and a manufacturer of the drug of the prescription information.

Other features and aspects will be apparent from the following detailed description, the drawings, and the claims.

### BRIEF DESCRIPTION OF THE DRAWINGS

FIG. 1 shows an immunization data system according to the related art.

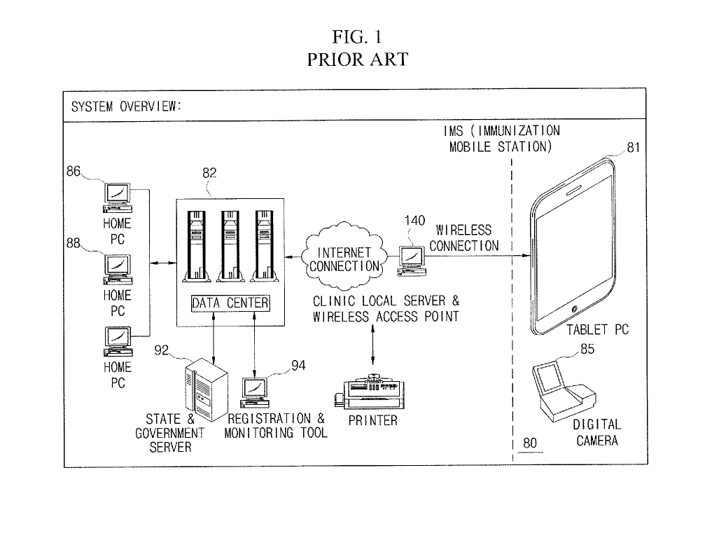

FIG. 2 is a block diagram showing an adverse drug event data system according to an embodiment of the present invention.

FIG. 3 is a block diagram showing a database unit of an adverse drug event data system according to an embodiment of the present invention.

FIG. 4 is a block diagram showing a device for collecting adverse drug event data according to an embodiment of the present invention.

FIG. 5 is a flowchart illustrating a method of searching for an adverse drug event data according to an embodiment of the present invention.

FIG. 6 is a flowchart illustrating a method of collecting adverse drug event data according to an embodiment of the present invention.

FIG. 7 is a view showing a screen for entering a drug-taking comment according to an embodiment of the present invention.

FIG. 8 is a view showing a search result for adverse drug event according to an embodiment of the present invention.

### DETAILED DESCRIPTION OF EMBODIMENTS

The advantages, features and aspects of the present invention will become apparent from the following description of the embodiments with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, specific embodiments will be described in detail with reference to the accompanying drawings.

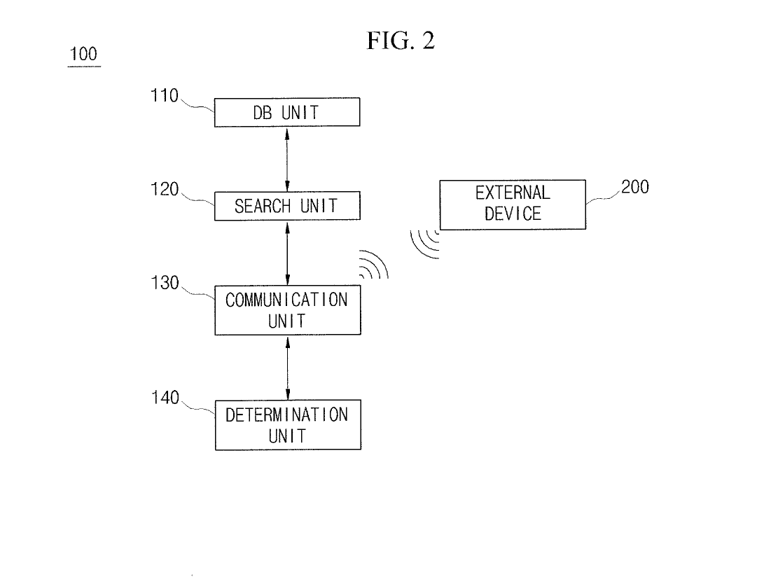

FIG. 2 is a block diagram showing an adverse drug event data system according to an embodiment of the present invention. Referring to FIG. 2, the adverse drug event data system includes a database (DB) unit 110, a search unit 120, a communication unit 130, and a determination unit 140.

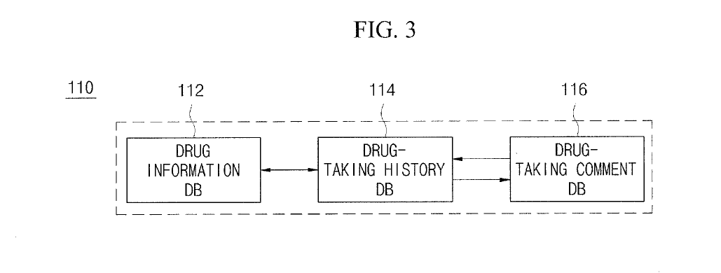

FIG. 3 is a block diagram showing a DB unit of an adverse drug event data system according to an embodiment of the present invention. Referring to FIG. 3, the DB unit 110 includes a drug information DB 112 for storing drug information, a drug-taking history DB 114 for storing a drug-taking history for a user, and a drug-taking comment DB 116 for storing drug-taking comments.

In particular, the drug-taking history DB 114 may store personal information that may be associated with the drug effectiveness, such as food and drinking habits of users, in addition to the previous prescription drug information.

The search unit 120 searches the DB unit 110 on the basis of the entered prescription information and then generates a drug interaction search result. Specifically, the search unit 120 generates the drug interaction search result through a combination of at least one of the drug information DB 112, the drug-taking history DB 114, and the drug-taking comment DB 116.

The communication unit 130 receives the prescription information and drug-taking comment information from the external device 200 and transmits the drug interaction search result to the external device 200. The external device 200 includes a mobile phone, a smartphone, a tablet PC, and the like, each of which has a wired or wireless networking function.

The determination unit 140 determines whether to cause the adverse drug event on the basis of the drug interaction search result and generates a determination result. When the determination unit 140 determines that the adverse drug event is caused, the communication unit 130 transmits the determination result to the external device 200.

The determination unit 140 determines that the adverse drug event is caused on the basis of the search result when a total amount of drug intake excesses the recommended amount of intake per day, a substance harmful to a human body is generated by reaction between a drug taken by a user and a food, or a drug-taking period is over a reference period recommended by a pharmaceutical firm.

For example, the determination unit 140 determines that the adverse drug event is caused when a total amount of acetaminophen (used in Tylenol) intake per a day excesses the recommended amount of intake per day of 4000 mg.

Subsequently, when a user drinks alcohol while taking Tylenol, the determination unit 140 determines that the adverse drug event is caused. This is because the drunk alcohol induces generation of a number of alcohol dehydrogenase enzymes (CYP2E1) in liver and the acetaminophen of Tylenol converts the alcohol dehydrogenase enzymes into toxic metabolites (NAPQI) to generate harmful substances.

In addition, when Tylenol of 4000 mg is taken per day during two weeks, the determination unit 140 determines that the adverse drug event is caused. This is because liver levels (ALT, AST), which indicate how much liver cells are damaged, increase by 40% or more, compared with the normal level.

Here, the drug interaction search result is at least one of information on interaction between the drug of the prescription information and another drug, information on interaction between the drug of the prescription information and a food, information on an adverse drug event of the drug of the prescription information, and information on components and a manufacturer of the drug of the prescription information.

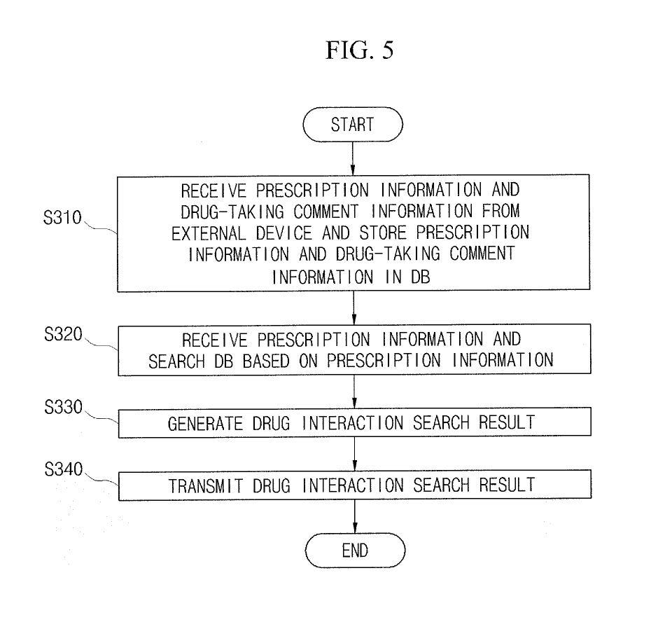

More specifically, the drug interaction information includes a search result for interaction between the drug currently or previously taken by the user and the drug of the newly acquired prescription information through search of a combination of the drug information DB 112 and at least one of the drug-taking history DB 114 and the drug-taking comment DB 116. The search result will be described below in detail with reference to FIG. 5.

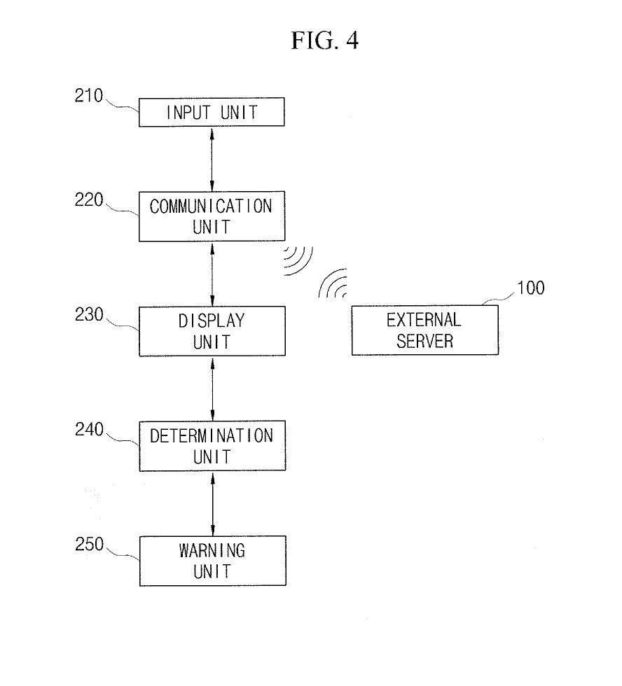

FIG. 4 is a block diagram showing a device for collecting adverse drug event data according to an embodiment of the present invention. Referring to FIG. 4, the device for collecting adverse drug event data includes an input unit 210, a communication unit 220, a display unit 230, a determination unit 240, and a warning unit 250.

Examples of the device for collecting adverse drug event data may include a smartphone and a tablet PC. A user enters adverse drug event data including prescription information and dug-taking comment information through the input unit 210, transmits the adverse drug event data to an external server 100 through the communication unit 220, searches the external server 100, receives a search result through the communication unit 220, and outputs the search result through the display unit 230.

The input unit 210 acquires the prescription information and dug-taking comment information. Specifically, the input unit 210 acquires the drug-taking comment information through at least one of a user's input and a selectable input window that is provided as a graphical user interface (GUI) and acquires drug information and prescription information through at least one of a user's input, a bar code, a QR code, and RFID information.

The communication unit 220 transmits the acquired prescription information and taking-drug comment information to the external server 100, and receives a drug interaction search result based on the prescription information and taking-drug comment information from the external server 100.

The display unit 230 outputs the received drug interaction search result.

The determination unit 240 determines that the adverse drug event is caused when a harmful substance is generated due to interaction between the drug and the food on the basis of the search result.

For example, when a drinking habit of user “A”, where user “A” drinks more than three units of alcohol everyday, is stored in the drug-taking history DB 114, and user “A” receives and enters a new prescription in which it is written that two pills are taken three times a day, the determination unit 240 determines that the adverse drug event is caused, by finding out the drinking habit of user “A” in the drug-taking history DB 114 and considering that the drunken alcohol induces generation of a number of alcohol dehydrogenase enzymes (CYP2E1) in the liver and the acetaminophen of Tylenol converts the alcohol dehydrogenase enzymes into toxic metabolites (NAPQI) to generate harmful substances.

The warning unit 250 delivers a warning message when the determination unit 240 determines that the adverse drug event is caused. Specifically, when the determination unit 240 determines that the adverse drug event is caused, the warning unit 250 generates warning sound, operate a flasher, and output a message saying that the adverse drug event is caused to the display unit 230. Accordingly, user “A” may immediately perceive that the adverse drug event may be caused and stop drinking alcohol or taking Tylenol.

FIG. 5 is a flowchart illustrating a method of searching for an adverse drug event data according to an embodiment of the present invention. As show in FIG. 5, the method includes receiving prescription information and drug-taking comment information from the external device 200 to store the prescription information and drug-taking comment information in a DB in operation 5310. Specifically, the method includes receiving the prescription information and drug-taking comment information through the communication 130 to store the prescription information and drug-taking comment information in the DB.

For example, when user “A” receives a prescription in which it is written that two pills of Mydrin including acetaminophen are taken three times a day due to headache and takes Mydrin, the prescription is received by user “A” from the external device 200 (for example, a smartphone, a tablet PC, etc.) and the received prescription is stored to the drug-taking history DB 114.

In addition, acetaminophen-taking comment information written by the third party is received and stored in the drug-taking comment DB 116. The taking comment information may include user “B” who takes Tylenol including acetaminophen for a long time to feel fatigued in everyday life due to liver damage and liver toxicity, user “C” who cannot stop bleeding due to reduction in platelet when taking Tylenol, and user “D” who has indigestion and difficulty in breathing when taking Tylenol.

Next, the method includes receiving the prescription information to search the DB unit on the basis of the received the prescription information in operation 5320. Specifically, the DB unit 110 is searched by the search unit 120 on the basis of the prescription information.

For example, when user “A” receives a prescription in which it is written that two pills of Tylenol are taken three times a day, the prescription information is received from the communication unit 220 of the external device and the DB 110 is searched based on the prescription information.

That is, the drug information DB 112, the drug-taking history DB 114, and the drug-taking comment DB 116 are searched based on the prescription information of user “A”. Accordingly, the drug information DB 112 is searched for acetaminophen, the drug-taking history DB 114 is searched for “user A” having taken Mydrin including acetaminophen from the past, the drug-taking comment DB 116 is searched for Tylenol having acetaminophen.

Next, the method includes generating a drug interaction search result through DB search in operation S330. Specifically, the search unit 120 generates the drug interaction search result.

It is determined whether to cause the adverse drug event on the basis of the generated drug interaction search result. Specifically, the determination unit 140 determines whether to cause the adverse drug event on the basis of the generated drug interaction search result.

If it is determined that the adverse drug event may be caused, a determination result is transmitted to the external device 200. Specifically, when the determination unit 140 determines that the adverse drug event is caused, the communication unit 130 transmits the result to the external device 200.

For example, when user “A” receives a prescription in which it is written that two pills of Tylenol are taken three times a day and takes Tylenol for a cold while receiving a prescription in which it is written that two pills of Mydrin are taken three times a day and takes Mydrin for a headache, one pill of Mydrin has acetaminophen of 325 mg, one pill of Tylenol has acetaminophen of 650 mg, and a total amount of acetaminophen intake per a day should not excess the recommended amount of intake per day of 4000 mg.

Accordingly, if user “A” takes Tylenol according to a new prescription while taking Mydrin, the total amount of acetaminophen intake per a day excesses 4000 mg, and the liver and the kidney are expected to be damaged. The determination unit 140 determines whether to cause the adverse drug event and transmits a determination result to the external device 200 through the communication unit 130. Thus, user “A” may perceive that the adverse drug event may be caused. Accordingly, user “A” may stop drinking or immediately taking Tylenol.

Lastly, the method includes transmitting the generated drug interaction search result to the external device 200 in operation S340.

Here, the drug interaction search result is at least one of information on interaction between a drug of the prescription information and another drug, information on interaction between the drug of the prescription information and a food, information on an adverse drug event of the drug of the prescription information, and information on components and a manufacturer of the drug of the prescription information.

For example, with respect to the information on interaction between a drug of the prescription information and another drug, when and an antibiotic (penicillin) is prescribed while iron tablets are usually taken, the antibiotic is slowly absorbed due to an influence of the iron tablets.

In addition, when Ibuprofen is taken as an analgesic while Aspirin is taken as a thrombus blocker, a thrombus blocking effect of Aspirin is extinguished.

With respect to the information on interaction between the drug of the prescription information and a food, when user “A” is prescribed Tylenol (two pills three times a day) and usually likes to drink soju, which is a Korean distilled liquor, liver damage and kidney damage are expected due to interaction between acetaminophen and alcohol.

With respect to the information on an adverse drug event of the drug of the prescription information, user “A” is prescribed Tylenol (two pills three times a day), and Tylenol mainly includes acetaminophen and has a recommended amount of intake per day of 4000 mg and has side effects of reduction in platelets, reduction in granulocytes, and anemia which are associated with blood, side effects of dyspnoea, low blood pressure, shock which are associated with hypersensitivity, and side effects of vomiting or disgusting, appetite lack, peptic ulcer, gastrointestinal bleeding, etc. which are associated with digestive disorder. In addition, Tylenol has side effects of rash and allergy which are associated with skin. When Tylenol is taken for a long time, Tylenol may lead to chronic liver injury, acute pancreatitis, chronic hepatitis, and nephrotoxicity.

With respect to the information on components and a manufacturer of the drug of the prescription information, the main component of Tylenol, which is prescribed for user “A”, is acetaminophen and the manufacturer thereof is Janssen Korea Ltd.

In addition, the drug interaction information includes a search result for interaction between a drug currently or previously taken by the user and a drug of a newly acquired prescription information.

For example, when user “A” is newly prescribed Tylenol for a cold (two pills three times a day) while user “A” takes two pills of Mydrin three times a day for a headache, user “A” is allowed to take a total amount of acetaminophen included in Mydrin and Tylenol, which excesses a recommended amount of intake per day of 4000 mg. Accordingly, user “A” may acquire information on interaction between acetaminophen of Mydrin and acetaminophen of Tylenol.

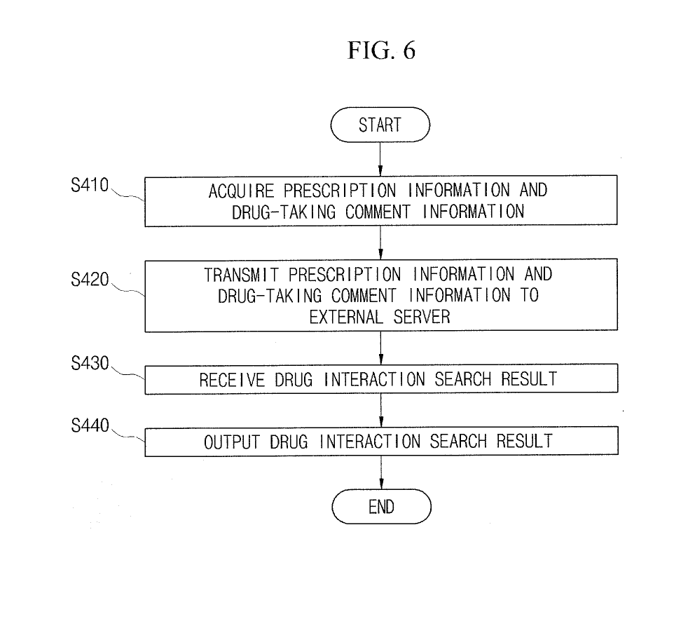

FIG. 6 is a flowchart illustrating a method of collecting adverse drug event data according to an embodiment of the present invention. As shown in FIG. 6, first, the method includes prescription information and drug-taking comment information in operation S410. Specifically, the prescription information is acquired through at least one of a user's input, bar code, QR code, and RFID information, and the drug-taking comment information is acquired through at least one of a user's input and a selectable input window that is provided as a graphical user interface (GUI).

For example, user “A” may enter the prescription information such as “Tylenol, two pills three times a day” through a user's input using a smartphone.

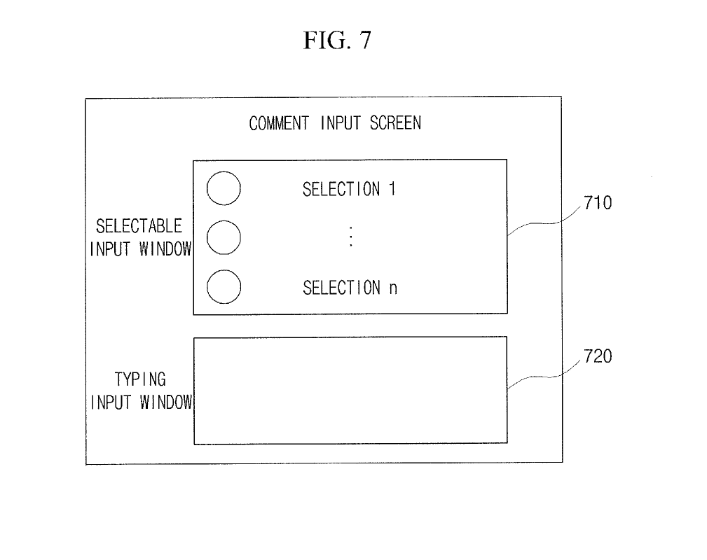

In addition, user “A” may enter the drug-taking comment information using the smartphone, through selection of the selectable input window 710 or directly. The selection of a selectable input window 710 will be described below with reference to FIG. 7.

Next, the method includes transmitting the acquired prescription information and drug-taking comment information to the external server 100 in operation S420. Specifically, the communication unit 220 transmits the acquired prescription information and drug-taking comment information to the external server 100.

Next, the method includes receiving a drug interaction search result from the external server 100 in operation 5430. Specifically, the communication unit 220 receives the drug interaction search result from the external server 100.

It is determined whether to cause the adverse drug event on the basis of the received drug interaction search result. Specifically, the determination unit 240 determines whether to cause the adverse drug event on the basis of the received drug interaction search result. For example, the determination unit 240 determines that the adverse drug event is caused when a prescribed drug excesses the recommended amount of intake per day, a harmful material is generated by reaction between a drug and a food, or a drug-taking period is over a reference period.

If it is determined that the adverse drug event is caused, a determination result is generated and then output. Specifically, if it is determined that the adverse drug event is caused, the determination unit 240 generates the determination result, and the display unit 230 outputs the determination result.

Lastly, the method includes outputting the received drug interaction search result in operation S440. Specifically, the display unit 230 outputs the received drug interaction search result.

Here, the drug interaction search result is at least one of information on interaction between the drug of the prescription information and another drug, information on interaction between the drug of the prescription information and a food, information on an adverse drug event of the drug of the prescription information, and information on components and a manufacturer of the drug of the prescription information. Its detailed description has been provided with reference to FIG. 5.

FIG. 7 is a view showing a screen for entering a drug-taking comment according to an embodiment of the present invention. As shown in FIG. 7, a selectable input window 710 and a typing input window 720 are displayed.

For example, user “A” who takes Tylenol may select at least one of “Selection 1: feel fatigued due to liver damage,” “Selection 2: rarely stop bleeding at a wound,” and “Selection 3: feel stomachache or difficulty in breathing.”

In addition, user “A” may directly compose a drug-taking comment of “after taking it, feel shocked and indigestion,” through the typing input window 720.

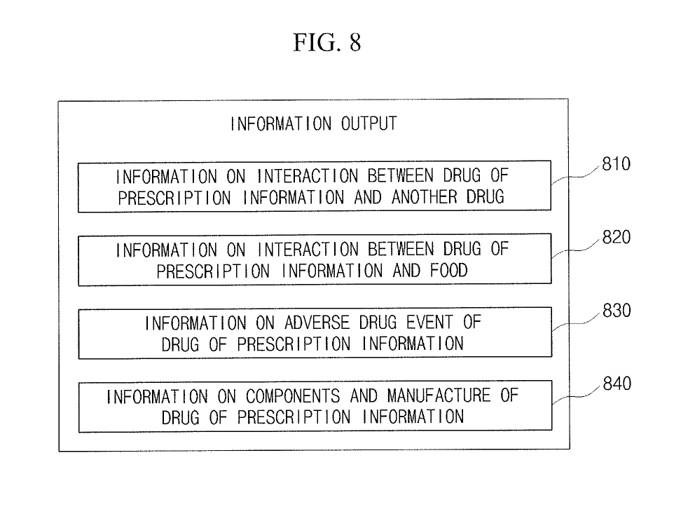

FIG. 8 is a view showing a drug interaction search result according to an embodiment of the present invention. As shown in FIG. 8, the drug interaction search result is at least one of information on interaction between the drug of the prescription information and another drug 810, information on interaction between the drug of the prescription information and a food 820, information on an adverse drug event of the drug of the prescription information 830, and information on components and a manufacturer of the drug of the prescription information 840.

According to the present invention, it is possible to receive the prescription information and drug-taking comment information from an external device to store the received prescription information and drug-taking comment information in a DB, receive the prescription information to search the DB on the basis of the received prescription information, generate a drug interaction search result through the DB search, and then transmit the generated drug interaction search result to the external device.

Accordingly, it is possible to allow a user to easily and effectively enter and collect drugs and drug-taking comments collected by the personal device that is connected to the network, search for and provide the additional information about the adverse drug event and drug effectiveness to the user, and analyze the collected drug-taking comments to perform adverse event mining for finding a new adverse event case.

It is also possible to allow a user to easily perceive that the adverse drug event may be caused and to allow a user to take a prompt action when the adverse drug event is expected to be caused, thereby preventing an adverse drug event accident.

The above-described subject matter of the present invention is to be considered illustrative and not restrictive, and it should be understood that numerous other modifications and embodiments can be devised by those skilled in the art that will fall within the spirit and scope of the principles of the present invention. Accordingly, the embodiments of the present invention are to be considered descriptive and not restrictive of the present invention, and do not limit the scope of the present invention. The scope of the present invention should be determined by the following claims and their appropriate legal equivalents.

What is claimed is:

1. An adverse drug event data system over a network, comprising:
a database (DB) unit configured to include a drug information DB for storing drug information, a drug-taking history DB for storing a drug-taking history, and a drug-taking comment DB for storing a drug-taking comment;
a search unit configured to search the DB unit based on prescription information and then generate a drug interaction search result; and
a communication unit configured to receive the prescription information and the drug-taking history from an external device and transmit the drug interaction search result to the external device,
wherein the drug interaction search result comprises at least one of information on interaction between a drug of the prescription information and another drug, information on interaction between the drug of the prescription information and a food, information on an adverse drug effect of the drug of the prescription information, and information on components and a manufacturer of the drug of the prescription information.

2. The adverse drug event data system of claim 1, wherein the drug interaction information comprises a search result for interaction between a drug currently or previously taken by a user and a drug of newly acquired prescription information through search of a combination of at least one of the drug information DB, the drug-taking history DB, and the drug-taking comment DB.

3. The adverse drug event data system of claim 1, wherein the search unit is configured to generate the drug interaction search result through search of a combination of at least one of the drug information DB, the drug-taking history DB, and the drug-taking comment DB.

4. The adverse drug event data system of claim 1, further comprising a determination unit configured to determine whether to cause an adverse drug event based on the drug interaction search result and generate a determination result,
wherein the communication unit transmits the determination result to the external device when the determination unit determines that the adverse drug event is caused.

5. The adverse drug event data system of claim 4, wherein the determination unit determines that an adverse drug event is caused based on the search result when a total intake amount of the drug excesses a recommended intake amount.

6. An apparatus for collecting adverse drug event data over a network, the apparatus comprising:
an input unit configured to acquire prescription information and drug-taking comment information;
a communication unit configured to transmit the acquired prescription information and drug-taking comment information to an external server and receive a drug interaction search result based on the prescription information and drug-taking comment information from the external server; and
a display unit configured to output the received drug interaction search result,
wherein the drug interaction search result comprises at least one of information on interaction between a drug of the prescription information and another drug, information on interaction between the drug of the prescription information and a food, information on an adverse drug effect of the drug of the prescription information, and information on components and a manufacturer of the drug of the prescription information.

7. The apparatus of claim 6, wherein the input unit acquires the drug-taking comment information through at least one of a user's input and a selectable input window that is provided as a graphical user interface (GUI), and acquires drug information and the prescription information through at least one of a user's input, a bar code, a QR code, and RFID information.

8. The apparatus of claim 6, further comprising a determination unit configured to determine that an adverse drug event is caused based on the search result when a harmful substance is generated due to interaction between the drug and a food.

9. The apparatus of claim 8, further comprising a warning unit configured to deliver a warning message when the determination unit determines that an adverse drug event is caused.

10. A method of searching for adverse drug event data over a network, the method comprising:
receiving prescription information and drug-taking comment information from an external device to store the received prescription information and drug-taking comment information in a database (DB);
receiving the prescription information to search the DB based on the received prescription information;
generating a drug interaction search result through the DB search; and
transmitting the generated drug interaction search result to the external device,
wherein the drug interaction search result comprises at least one of information on interaction between a drug of the prescription information and another drug, information on interaction between the drug of the prescription information and a food, information on an adverse drug effect of the drug of the prescription information, and information on components and a manufacturer of the drug of the prescription information.

11. The method of claim 10, wherein the drug interaction information comprises a search result for interaction between a drug currently or previously taken by the user and a drug of newly acquired prescription information.

12. The method of claim 10, further comprising:
determining whether to cause an adverse drug event based on the generated drug interaction search result; and
generating a determination result when it is determined that the adverse drug event may be caused, to transmit the generated determination result to the external device.

13. A method of collecting adverse drug event data over a network, the method comprising:
acquiring prescription information and drug-taking comment information;
transmitting the acquired prescription information and drug-taking comment information to an external server;
receiving a drug interaction search result from the external server; and
outputting the received drug interaction search result,
wherein the drug interaction search result comprises at least one of information on interaction between a drug of the prescription information and another drug, information on interaction between the drug of the prescription information and a food, information on an adverse drug effect of the drug of the prescription information, and information on components and a manufacturer of the drug of the prescription information.

14. The method of claim 13, wherein the acquiring comprises acquiring the prescription information through at least one of a user's input, a bar code, a QR code, and RFID information, and acquiring the drug-taking comment information through at least one of a user's input and a selectable input window that is provided as a graphical user interface (GUI).

15. The method of claim 13, further comprising:
determining whether to cause an adverse drug event based on the received drug interaction search result; and
when it is determined that the adverse drug event is caused, generating a determination result to transmit the generated determination result.
